(19) United States
(12) Patent Application Publication
(10) Pub. No.: US 2007/0051226 A1
(43) Pub. Date: Mar. 8, 2007

(54) Musical instrument fingering extraction and training

(76) Inventor: Carlos Diaz, Fremont, CA (US)

Correspondence Address: PATENTS PENDING, 9832 LOIS STILTNER CT, ELK GROVE, CA, 95624, US

(21) Appl. No.: 11/248,512

(22) Filed: Oct. 12, 2005

Related U.S. Application Data
(60) Provisional application No. 60/714,252, filed on Sep. 6, 2005.

(51) Int. Cl. G09B 15/02; G09B 15/00; G10H 1/00

(52) U.S. Cl. 84/477 R

(57) ABSTRACT

An acoustic guitar is fitted with a fingering display embedded in its fretboard. A fingering-display processor with tempo control allows a user to select a tune to practice and the speed of tempo to use. The user is progressively shown where to finger each successive note and chord in a tune. A fingering extraction processor downloads fingering patterns that have been discerned from input tunes that are whistled, hummed, played on another instrument, or performed by an orchestra. A microphone is used to capture ambient sounds, and an electronic audio input is used to collect recorded or broadcast performances. The fingering extraction processor is implemented with a digital signal processor that samples analog audio inputs. Such inputs are filtered for noise and interstitial breaks indicating start-end of play. Orchestral performances are filtered by voice to create a guitar fingering arrangements. The fingering extraction processor can be collocated with the fingering display processor. And the fingering display processor can be attached to or integrated within a guitar.

### RELATED APPLICATIONS

Applicant claims priority from U.S. Provisional patent application, titled SMART MUSICAL INSTRUMENT TRAINING AID, Ser. No. 60/714,252, filed Sep. 6, 2005.

### BACKGROUND

1. Field of the Invention

The present invention relates to musical instruments, and more particularly to methods and devices for teaching a user the fingerings necessary to recite and practice various tunes. And wherein the fingerings are extracted from live or recorded performances and digitally stored.

2. Description of the Prior Art

Many people without music theory training or study can nevertheless play a tune on a guitar or piano because they have memorized the fingering patterns necessary. Learning to read music, and then to apply it to a particular instrument can be difficult, challenging, intimidating, and plain boring to many hobbyists. Getting right to the music you want to play and hear is far more interesting, stimulating, and motivating.

Dorothea Weitzner describes in U.S. Pat. No. 3,403,591, issued Oct. 1, 1968, an ordinary acoustic guitar with an array of lights in a matrix attached next to the fretboard or beneath it. The matrix mimics the positions of the strings and frets, and is intended to display to the user how to finger the fretboard for various tunes. A music display box rolls sheet music past a window for viewing during play. The backside of the roll has conductive stripes in digital patterns that are contacted in parallel by sliding wire brushes. A tempo control adjust the speed of playback by controlling the rotation of the sheet music roll. The brushes make and break contact with the conductive stripes to light the corresponding lamps in the fretboard matrix. The system is very inflexible in that new music requires a new roll of sheet music with the correct digital conductive stripes to be inserted into the music display box.

A similar system, but using modern LCD's, LED's and electronics, is described by Frederick Breitweiser, Jr., et al., in U.S. Pat. No. 5,408,914, issued Apr. 25, 1995. The LCD's and LED's are used to display directly on the fretboard the name of the note or chord, the fingers to use, and the string/fret position to press. FIG. 7 shows the data to use is generated by a microprocessor with an analog-to-digital converter (ADC) connected to receive an audio input from a stereo. A cable connects the stereo to the microprocessor sub-system, and another cable connects to the fretboard display in the guitar. Real-time and freeze modes are described to assist training. The Disclosure provides no enabling details on how the microprocessor sorts through the ordinary playback of a stereo to discern the notes or chords in a melody, or how these are electronically correlated to the notes playable by a guitar. The input to the microprocessor is limited to an audio jack that cables to one channel of a stereo.

A much simpler system that only shows the fingering patterns for a limited number of notes and chords is described by John Roof, in U.S. Pat. No. 4,286,495, issued Sep. 1, 1981. A series of switches mounted near the sounding hole are used to statically select which patterns to light up on the fretboard.

The prior art also includes learning devices for pianos, trumpets, flutes, and guitars. Thomas Sherlock describes a display, e.g., that lays across the keyboard of a piano in U.S. patent application 2002/0177113, published Nov. 28, 2002. The stated advantage is users are not required to be able to read music. FIG. 1 illustrates a microprocessor system with various inputs, outputs, displays, and memories. No design or engineering details are provided about the software that allows the conventional hardware in the drawings to accomplish the stated objectives or purposes. The system is alleged to be compatible with a wide variety of input sources, including digital, serial, and disc. One teaching is that a musical score is converted off-line to MIDI format by a person skilled at reading music. The invention therefore is not self-sufficient, and requires the purchase or expert-generation of specialized programs, recordings, and inputs to play new songs.

The control, background, and instructional data for a guitar fitted with a fretboard fingering display can be stored and played back on a CD player. Steven Johnson describes this in U.S. Pat. No. 6,191,348, issued Feb. 20, 2001. Finger sensors are included to provide feedback on how well the user's fingering compares with the program display. Programming material can be downloaded from the Internet and other sources. Nothing describes listening to live music and extracting the guitar fingering information from the acoustic or electronic analog sound.

Conventional methods for teaching students to play stringed instrument have included the study of music theory, e.g., scales and chord progressions. The actual learning by these methods is boring and cumbersome because the student is often limited to pre-stored music and is constrained by their lack of music theory education.

What is needed is a musical instrument training system that can actually “learn” the tune or melody to be played. Instead, prior art systems rely on pre-stored music. It would be better if these devices could learn the tune or melody in real-time, and extract the fingering information for display and training.

### SUMMARY OF THE INVENTION

An object of the present invention is to provide musical instrument training, entertainment, and an easy method of learning and playing a guitar and other musical instruments.

Briefly, a self-programmable teaching guitar embodiment of the present invention comprises an acoustic guitar fitted with a fingering display embedded in its fretboard. A fingering display processor with tempo control allows a user to select a tune to practice and the speed of tempo to use. Lights under the correct strings and frets are used to show the user where to finger each successive note and chord in a tune. A fingering extraction processor in periodic communication with the fingering display processor downloads fingering patterns that have been discerned from input tunes that are whistled, hummed, played on another instrument, or performed by an orchestra. A microphone is used to capture ambient sounds, and an electronic audio input is used to collect recorded or broadcast performances. The fingering extraction processor is implemented with a digital signal processor that samples analog audio inputs. Such inputs are filtered for noise and interstitial breaks indicating start-end of play. Orchestral performances are filtered by voice to pick out and replicate the guitar voices, or to create a guitar fingering arrangement from another instrument's play. The fingering extraction processor can be hosted as software on a separate personal computer and wirelessly connected, or it can be collocated with the fingering display processor embedded in the guitar.

An advantage of the present invention is that a self-programmable teaching guitar and method are provided for users to practice fingerings for their favorite tunes.

Another advantage of the present invention is that a self-programmable teaching guitar and method are provided that can extract guitar fingerings from tunes that are whistled, sung, hummed, played on another instrument, or performed by an orchestra.

A further advantage of the present invention is that a musical instrument fingering extraction and training system are provided for users to practice fingerings for their favorite tunes on a variety of target instruments.

A still further advantage of the present invention is that a musical instrument fingering extraction and training system are provided that can pick a single instruments performance out of a orchestral recital and transform its arrangement to a fingering arrangement for a target instrument.

An advantage of an LED-guitar embodiment of the present invention is a user can control the number and progression speed of notes they want to learn, and bits such can be repeated over and over.

These and other objects and advantages of the present invention will no doubt become obvious to those of ordinary skill in the art after having read the following detailed description of the preferred embodiments which are illustrated in the various drawing figures.

### IN THE DRAWINGS

FIG. 1 is a perspective view diagram of a guitar learning system embodiment of the present invention;

FIG. 2 is a functional block diagram of a musical instrument fingering extraction and training system embodiment of the present invention;

FIG. 3 is a perspective diagram of a fingerboard training module embodiment of the present invention being slipped under the strings and over the fretboard of an ordinary acoustic guitar;

FIG. 4 is a detail diagram of the top end of the fingerboard training module of FIG. 3 showing the arrangement of LED lights that guide the user during play; and

FIG. 5 is an exploded side view of the fingerboard training module and acoustic guitar of FIG. 3 showing the assembly of the components.

### DETAILED DESCRIPTION OF THE PREFERRED EMBODIMENT

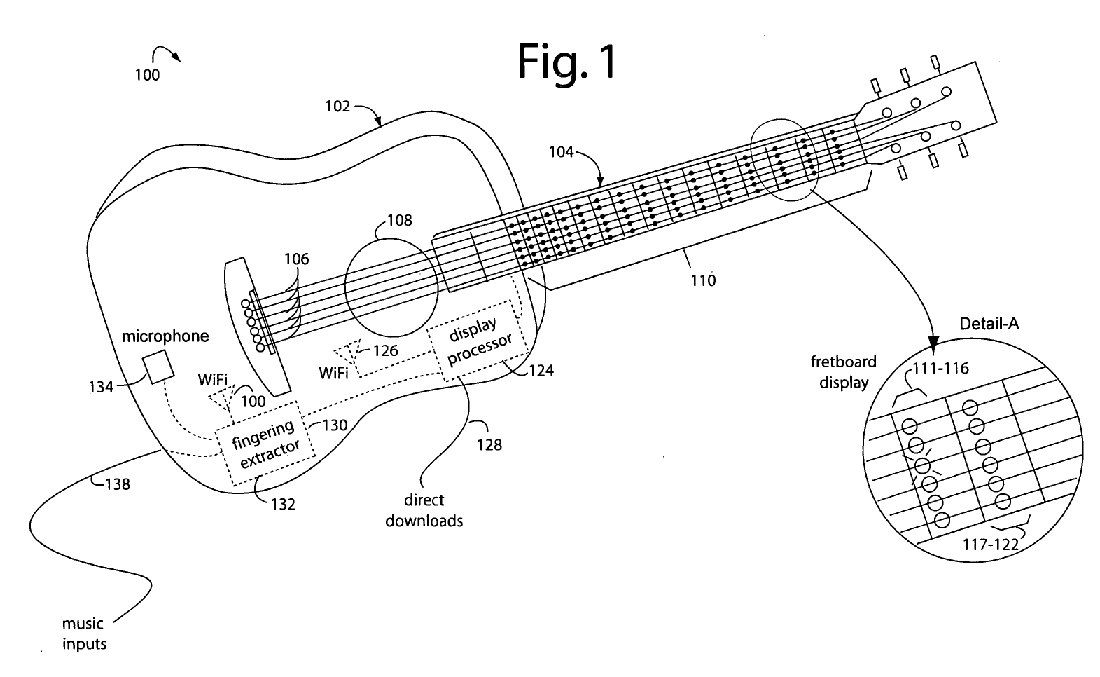

FIG. 1 represents a guitar learning system embodiment of the present invention, and is referred to herein by the general reference numeral 100. The guitar learning system 100 comprises an acoustic guitar 102 conventionally equipped with a fretboard 104, strings 106, and a sounding hole 108. The most common tuning used is known as “standard tuning”, e.g., sixth (lowest) string: E (a minor thirteenth below middle C-82.4 Hz); fifth string: A (a minor tenth below middle C-110 Hz); fourth string: D (a minor seventh below middle C-146.8 Hz); third string: G (a perfect fourth below middle C-196.0 Hz); second string: B (a minor second below middle C-246.92 Hz); and, first (highest) string: E′ (a major third above middle C-329.6 Hz). Standard tuning evolved to provide a good compromise between simple chord fingering and minimal left hand movement for common scales. All adjacent string pairs, except the (G-B), are separated by the same interval. A perfect fourth, equivalent to a distance of five frets, provides comfortable fingering patterns. The major third, four frets between the G and B strings allows the playing of many chords and scales. It further provides some in fingering diversity. Many figures which are difficult to play on strings tuned a fourth apart are easier to play on strings tuned a third apart, and vice versa.

As shown in FIG. 1, detail-A, embodiments of the present invention inlay or attach a fretboard display 110 represented by indicators 111-116 and 117-122. Such indicators can be implemented with a variety of technologies, e.g., LED, LCD, incandescent lamp, etc. The object of these indicators is to show a user the string and fret positions to be fingered at any one time. A display processor 124, disposed in the guitar body, drives the fretboard display 110 according to a tune selected by the user. These tunes are stored as sequences of S,F,T matrices, where S is the string, F is the fret, and T is the time to apply and hold the fingering. The sequences advance according to a tempo control. The display processor 124 allows the user to choose programs to play and practice, and it accepts program downloads from a variety of sources including wireless (WiFi) 126, direct downloads 128, and a fingering extractor 132. A stand-alone, self-sufficient system would be realized if the fingering extractor 132 is collocated with the display processor 124 inside guitar 102. Otherwise, the fingering extractor 132 can be implemented as an applications programming interface (API) hosted on a conventional personal computer with wired or wireless communication.

Clutter and acoustically disruptive wiring and circuit modules inside the guitar body can be reduced in size and number to give the guitar body a cleaner appearance by using wireless and infrared (IR) remote control technologies to control the operation of the display processor 124.

Alternative embodiments of the present invention include implementations with other types of instruments using fingering, e.g., electric guitars, violas, tubas, trumpets, flutes, pianos, saxophones, etc.

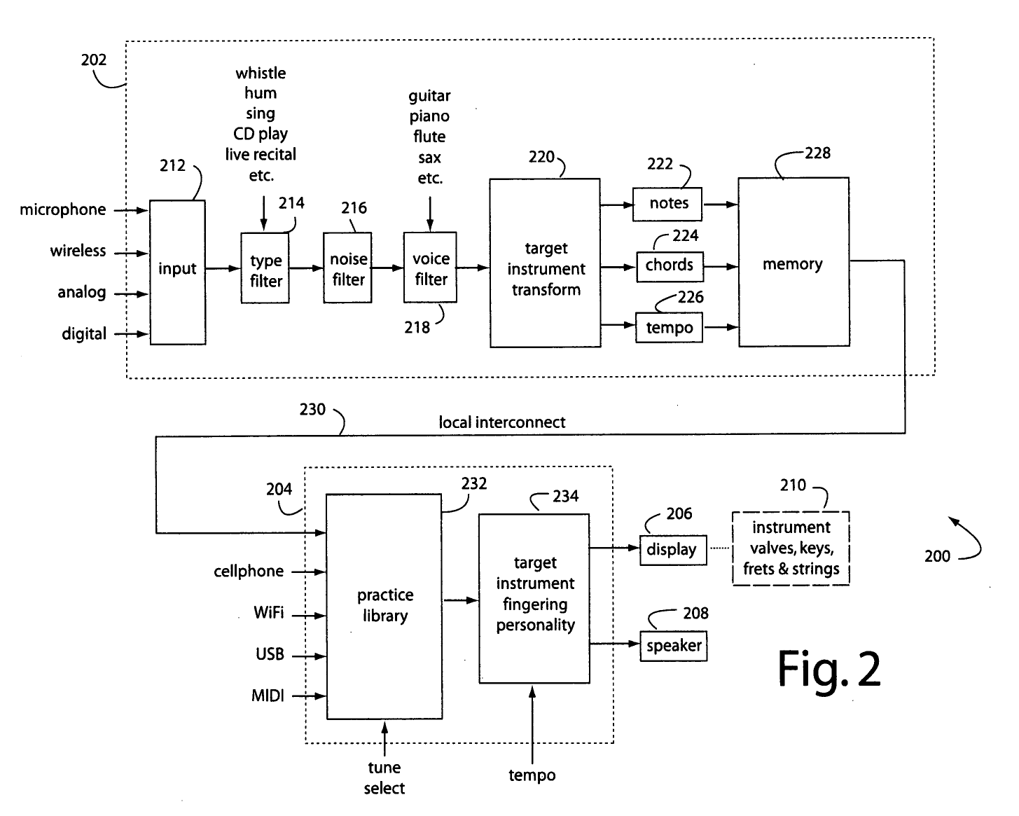

FIG. 2 represents a musical instrument fingering extraction and training system embodiment of the present invention, and is referred to herein by the general reference numeral 200. The system 200 comprises a fingering extractor 202, a display processor 204, a fingering display 206, and a speaker 208. The fingering display 206 is collocated with the valves, keys, or strings & frets of a target instrument 210. For example, the valves of a sax or trumpet, the keys of a piano or accordion, and the strings & frets of an acoustic guitar or electric bass.

The fingering extractor 202 can be implemented as an applications programming interface (API) downloadable by purchase on the Internet to a conventional personal computer. Otherwise, it can be implemented on a digital signal processor with an analog-to-digital converter (ADC) input. A variety of hardwired inputs are selected by an input source multiplexer 212, and can include microphone, wireless, analog, and digital. Industry standard formats and specifications are preferred for use.

A type filter 214 allows the system to be given a sort of heads-up as to what kind of source material to expect. For example, if the source is to be the whistling of someone near the microphone, then allowances need to be made for off-key and off-tempo recitals. It may also be advantageous to try to recognize the tune being whistled and substitute it with a clean music library copy. Problems with the tempo, as when whistled, can be automatically corrected without a library model copy. Other types of musical background can be excluded, or tuned out, if not selected.

A noise filter 216 removes background, ambient, white noise, clicks, pops, human voices, machinery and other interferences from the pure musical tones being input.

Each musical instrument has its own voice or signature, and these are highly recognizable. The voices are characterized by their waveform attacks, sustains, decays, and harmonics. The system 200 allows the recital of one instrument to be transformed to the fingering arrangement needed for a target instrument, e.g., a piano to a guitar. A voice filter 218 removes all other sounds and noises surrounding an instrument-of-interest, e.g., the sounds of an orchestra are stripped away to leave only that of a guitar in the orchestra. A target instrument transform 220 then converts the notes 220, chords 224, and tempo 226 observed for the instrument-of-interest to that of a selected target instrument. The user inputs to the voice filter 218 which voices are to be preferred and captured.

A memory 228 is used to temporarily hold and store for forwarding the arrangements that have been extracted. Large memories are relatively inexpensive now, so it would be very practical to store large libraries of arrangements for a variety of tunes and target instruments. These could be shared or sold over the Internet. The guitar 100, FIG. 1, would dispose the fingering processor 202 with the display processor 204, so a local interconnect 230 would be used inside the guitar body. Alternatively, if the fingering processor 202 were implemented as software on a personal computer, the downloads could arrive via cellphone, WiFi (802.11b/g), USB, or MIDI formats.

The display processor 204 includes a practice library 232 used to input and store tune arrangements the user would like to learn. These can be received over a local interconnect 230, by cellphone, WiFi, USB, or MIDI interface. A USB flash memory dongle would be an efficient way to introduce new data. Selected practice tunes are forwarded to a target instrument fingering personality to generate the correct fingering progressions for sounding on the speaker 208 and indication on display 206.

The fingering extractor 132 compiles guitar fingering sequences from raw musical sources, e.g., a whistled tune, another instrument being played, a music CD, a broadcast, etc. A microphone 134 allows ambient sound input. A wireless (WiFi) input 136 allows cellphone, 802.11, infrared, and other types of communications. A cable 138 allows local sources such as CD players, MIDI, and DVD sources to be accepted.

Embodiments of the present invention will benefit people with or without knowledge of music theory. A smart LED-guitar embodiment of the present invention would have as an input source, a radio, CD player, record player, another guitar, and even a person whistling, humming, etc. MIDI players, and music downloaded from the Internet would also work. Such sound sources can be picked up by a microphone built into the LED-guitar, or cabled. After a LED-guitar “learns” a tune, it can replay the tune by driving fretboard display LED's one-by-one in an orderly manner as to represent the learned tune or melody. Such can be a single note at a time, or two or more notes at the same time.

The learning mode essentially means that incoming tunes are filtered so purer incoming waveform frequencies can be extracted and saved in memory. The results are mapped to correspond the LED or LED's to be lit on the LED-guitar.

For Internet applications, a user could upload their CD's into a web server so the S,F,T values could be extracted and downloaded. Such values could be saved in a USB flash memory to be used later by the LED-guitar. During playback, LED's are lit at the correct time when there is a new note to be played, e.g., as controlled by a micro-controller embedded in the neck of the LED-guitar, or by a separate microcomputer. The user fingers the notes guided by the LED's. A speaker can be used to provide an audible feedback to the user.

In general, a smart musical instrument training aid incorporates electronic circuits in a musical instrument to extract fingering patterns from incoming musical tunes. A prototype, a LED-guitar was fitted with electronic circuits and LED's were embedded in the neck. A user is taught to watch the fretboard display and follow the fingering patterns represented.

In one example of a teacher and student with a LED-guitar, the teacher starts playing a tune. The student switches their LED-guitar to the learning mode. After a minute or two, the teacher can stop playing. Then, the student with the LED-guitar, switches to the playing mode. The LED-guitar will start lighting the correct LED's one-by-one that correspond to the tune that was just learned.

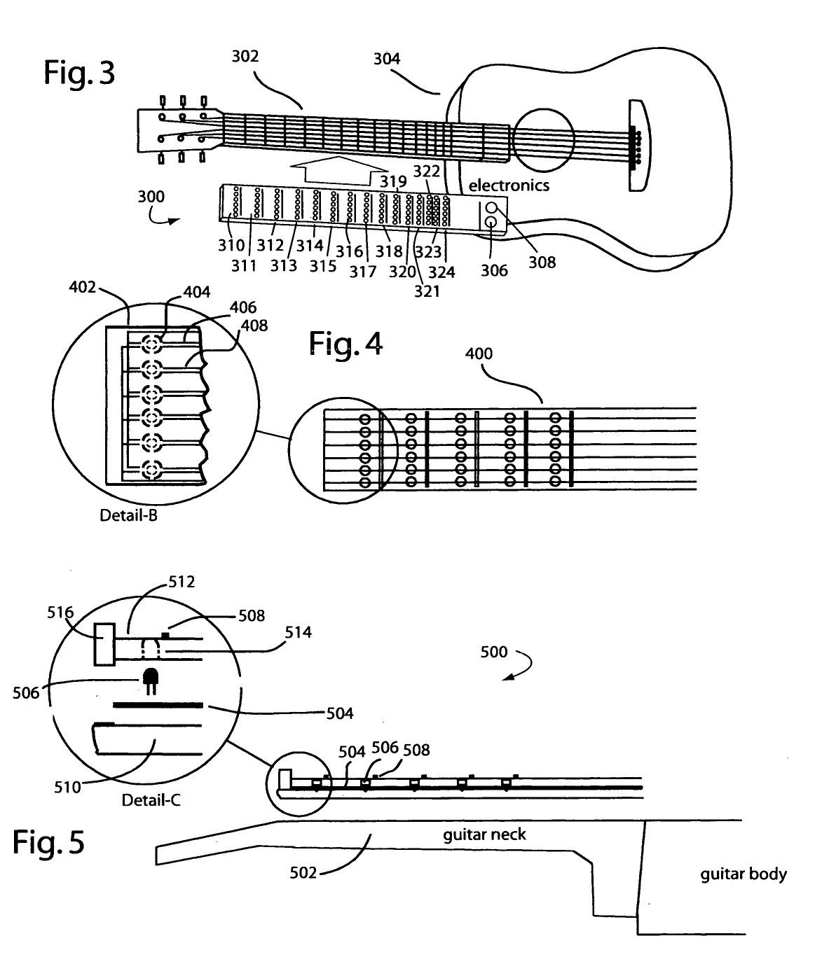

FIG. 3 represents a fingerboard training module embodiment of the present invention, and is referred to herein by the general reference numeral 300. The module 300 is shown being slipped under the strings and over a fretboard 302 of an ordinary acoustic guitar 304. It includes a microphone 306 to pickup the sounds of the guitar strings as feedback to compare the instruction to the performance, and a speaker 308 to sound tuning notes, audio instruction, model play, etc. Several rows of fret-lights 310-325 individually light up to show the user where and when to finger a tune being taught. Module 300 can be battery powered, or equipped with a jack to receive low voltage DC-power from an AC-adapter.

Module 300 is advantageously implemented as a wireless, battery powered unit that incorporates some or all of the functionality detailed in FIG. 2. That which is not disposed in module 300 can be implemented with downloadable software on an available laptop computer equipped with a microphone and WiFi and USB interfaces.

FIG. 4 is a detail diagram of a top end 400 of the fingerboard training module of FIG. 3. A Detail-B shows a module 402 decorated with a typical arrangement of fret-lights 404 to guide the user during play. Each row has a fret-light for each corresponding string, e.g., strings 406 and 408.

FIG. 5 represents a fingerboard training module 500 for removable attachment to an acoustic guitar 502. For example, a user would remove the strings from guitar 502, lay the module 500 down on the bare guitar neck, and then reinstall the strings. The microphone 306 (FIG. 3) could then be used to listen to the strum of each open string to help retune each. The speaker 308 can be used to sound out a tone for the user to adjust the string for the right tuning. The module 500 comprises a printed circuit board (PCB) 504 with LED's 506 disposed by corresponding frets 508. Detail-C shows how the module 500 can be constructed by soldering LED's 506 to the PCB 504 and then sandwiching between a base 510 and an overlay 512 with relief 514 and a “nut” 516 which is a piece of plastic or metal between the headstock and fretboard. The nut 516 guides the strings from the headstock and tuners over the fretboard.

During the programming of a prototype embodiment of the present invention, it was found useful to number the strings 100, 200, 300, 400, 500, etc., and the frets with 1, 2, 3, 3, 4, etc. Then a particular string and fret position could easily be visualized by both the software programmer and the music student, e.g., “405” referred to the fifth fret on the fourth string.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

What is claimed is:

1. A musical instrument fingering extraction and training system, comprising:
a fingering extraction processor for recognizing notes from a tune being input, and for converting and storing those into electronic representations of fingering patterns for playing a musical instrument in a later performance of said tune;
a fingering display for a positioning proximate to a particular musical instrument such that a user can be guided in playing said tune on it; and
a fingering display processor for converting said electronic representations of fingering patterns in real-time according to user controls of tempo and tune selection.

2. The system of claim 1, wherein the fingering extraction processor further comprises:
a source input selector for choosing amongst microphone, wireless, analog, and digital musical sources.

3. The system of claim 1, wherein the fingering extraction processor further comprises:
a filter to comb out sounds not-of-interest in the direct conversion of musical sources to fingering patterns.

4. The system of claim 1, wherein the fingering extraction processor further comprises:
a transform process for mapping sounds from musical sources into corresponding fingerings on said musical instrument.

5. The system of claim 1, wherein the fingering display processor further comprises:
a practice library of fingering patterns and sequences related to a particular tune that can be selected by a user.

6. The system of claim 1, wherein the fingering display processor further comprises:
a target instrument fingering personality for converting a generalized set of fingering patterns and sequences related to a particular tune into a specific set for a target musical instrument to be used proximate to the fingering display.

7. A musical instrument fingering extraction and training system, comprising:
a fingering extraction processor for recognizing notes from a tune being input, and for converting and storing those into electronic representations of fingering patterns for playing a musical instrument in a later performance of said tune;
a fingering display for a positioning proximate to a particular musical instrument such that a user can be guided in playing said tune on it;
a fingering display processor for converting said electronic representations of fingering patterns in real-time according to user controls of tempo and tune selection;
a source input selector for choosing amongst microphone, wireless, analog, and digital musical sources;
a filter to comb out sounds not-of-interest in the direct conversion of musical sources to fingering patterns;
a transform process for mapping sounds from musical sources into corresponding fingerings on said musical instrument;
a practice library of fingering patterns and sequences related to a particular tune that can be selected by a user; and
a target instrument fingering personality for converting a generalized set of fingering patterns and sequences related to a particular tune into a specific set for a target musical instrument to be used proximate to the fingering display.

8. The system of claim 7, wherein:
the fingering extraction processor is implemented with software on a personal computer that can communicate remotely to the fingering display processor.

9. The system of claim 7, wherein:
the fingering display processor and fingering display are implemented as a module suitable for temporary installation on the fretboard and under the strings of a conventional acoustic guitar.

10. The system of claim 7, wherein:
the fingering display is integrated into the fretboard and under the strings of an acoustic guitar.
